(19) United States
(12) Patent Application Publication
(10) Pub. No.: US 2007/0116949 A1
(43) Pub. Date: May 24, 2007

(54) Shading decorative sheet

(76) Inventors: Kazuo Hayashi, Tokyo (JP); Aki Omachi, Tokyo (JP); Masao Omori, Yamagata-Prefecture (JP)

Correspondence Address: 3M INNOVATIVE PROPERTIES COMPANY, PO BOX 33427, ST. PAUL, MN, 55133-3427, US

(21) Appl. No.: 10/562,094

(22) PCT Filed: Jun. 30, 2004
(86) PCT No.: PCT/US04/21104

§ 371 Date: Dec. 21, 2005

(30) Foreign Application Priority Data
Jun. 30, 2003 (JP) 2003-186900

(51) Int. Cl. B32B 7/12; B32B 15/04

(52) U.S. Cl. 428/354; 428/343

(57) ABSTRACT

A shading decorative sheet comprises a transparent base layer having a back face and a front face opposing to the back face, which comprises a thermoplastic resin film, a decorative layer provided on said front face of the base layer, which has a gradation pattern at least in one direction, and an adhesive layer fixedly provided on said back face of the base layer, wherein said gradation pattern comprises an opaque region having a haze of at least 30% when measured according to ASTM D 1003-00 and a transparent region, and a ratio of the areas of the two regions is changed at least in one direction.

### FIELD

The present invention relates to a shading decorative sheet. In particular, the present invention relates to a shading decorative sheet having improved design by the formation of a gradation pattern at least in one direction, in which the gradation pattern is formed by changing a ratio of the area of opaque regions and the area of transparent regions in a specific direction.

With the shading decorative sheet of the present invention, a viewer can see an object behind the sheet through an area having a high percentage of the transparent region(s) (a recognizable part), while an area having a high percentage of the opaque region(s) (a non-recognizable part) has a blinding effect.

The shading decorative sheet of the present invention can be used as a shading decorative sheet for building facilities such as panes, partitions, handrail glasses, etc., and vehicles.

### BACKGROUND

Hitherto, a part of a transparent body such as a pane or a partition, which is desirably shielded, is laminated with a printed sheet or a mat sheet to interrupt a line of vision. However, when such a sheet is adhered to a transparent body such as a pane, a boundary between a part to which the sheet is adhered and other part to which no sheet is adhered is clearly seen so that the decorativeness deteriorates.

A design-improved sheet having a gradation is disclosed in Japanese Patent JP-A 2002-2192. The sheet disclosed in Patent Literature 1 is characterized in that, in any area having the gradation, a color difference ΔE, which changes in a measuring distance of 2.0 mm, is at least 2 (ΔE≧2). Although this sheet has good decorativeness, it is not suitable for partly shielding an adherent to which the sheet is adhered.

Japanese Utility Model Registration No. 3059047 discloses a sheet for an automobile window glass, which is characterized in that a gradation pattern is formed along a horizontal direction of the vehicle. The gradation pattern of the disclosed sheet is designed such that a light-colored part of the gradation pattern is present on the both windows of a front sheet and a windshield so that a driver can see the outside views, while a dark-colored part of the gradation is present on a rear window and the both windows of a rear sheet so that the interior of the automobile is not easily viewed from outside. In Japanese Utility Model Registration No. 3059047 a sharp change of tint is suppressed to solve the problem of the deterioration of decorativeness. Furthermore, the gradation vanishes the sharp change at the boundary between the light-colored part and the dark-colored part, and thus the driver's view is retained to improve the safety.

### SUMMARY OF THE INVENTION

When the sheets disclosed in the above prior art are used, it is possible to maintain the view to some extent in the part having the gradation while providing a good design. However, since the darkness of the gradation of the above sheets changes continuously and smoothly, such sheets are insufficient for correctly recognizing an object behind the sheets through the part having the gradation. This may be because the gradation is formed by changing a ratio of areas and sizes of small dots (each dot being so small as not to be recognized with an eye) which form the gradation

The gradation changes from the dark-colored part to the light-colored part. However, it is impossible to know from which part an object behind the sheet can be seen, before the sheet is actually adhered to a transparent body.

The present invention solves the above problems and provides a shading decorative sheet in which a gradation is formed not from small dots but is formed by changing a ratio of the area of an opaque region having a specific haze when measured according to ASTM D 1003-00 to that of a transparent region. Furthermore, the present invention provides a shading decorative sheet which has a distinct boundary between a recognizable part and a non-recognizable part by defining a ratio of the area of the opaque region to that of the transparent region.

To solve the above problems, the present invention provides a shading decorative sheet comprising:
a transparent base layer having a back face and a front face opposing to-the back face, which comprises a thermoplastic resin film,
a decorative layer provided on said front face of the base layer, which has a gradation pattern at least in one direction, and
an adhesive layer fixedly provided on said back face of the base layer,
   wherein said gradation pattern comprises an opaque region having a haze of at least 30% when measured according to ASTM D 1003-00 and a transparent region, and a ratio of the areas of the two regions is changed at least in one direction.

### BRIEF DESCRIPTION OF THE DRAWINGS

FIG. 1 is a schematic cross sectional view of one embodiment of the shading decorative sheet of the present invention.

FIG. 2 shows a schematic plan view of the shading decorative sheet of FIG. 1, and also the length of each part in the gradation direction and the percentages of the opaque region.

FIG. 3 shows the placement of an object and a partition glass to which a shading decorative sheet is adhered, when the shielding effect is measured in the Example.

### DETAILED DESCRIPTION

Now, the shading decorative sheet of the present invention will be explained by making reference to the accompanying drawings.

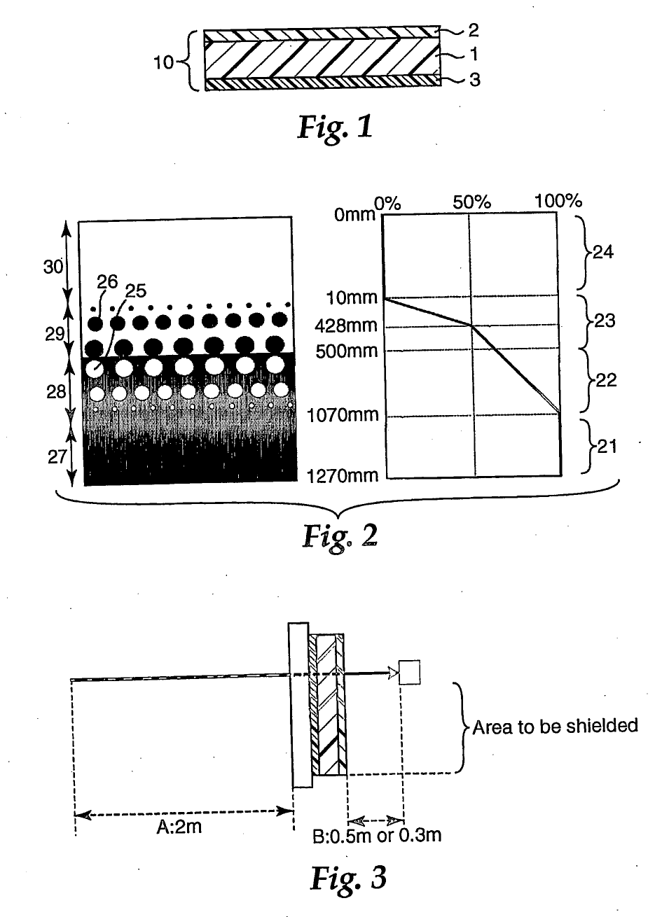

FIG. 1 is a schematic cross sectional view of one embodiment of the shading decorative sheet of the present invention. The shading decorative sheet 10 shown in FIG. 1 comprises the base layer 1 of a thermoplastic resin film, a decorative layer 2 formed on the front face of the base layer 1, and the adhesive layer 3 provided on the back face of the base layer 1.

The thermoplastic resin film may be any film of conventional thermoplastic resins, and can be produced from a polyvinyl chloride resin, a vinyl chloride-vinyl acetate copolymer resin, an acrylic resin, a polypropylene resin, a polyethylene resin, a polyester resin, a polyolefin resin, etc. These resins may be used as a blend thereof. The polyvinyl chloride resin contains a plasticizer which imparts flexibility to the resin. Examples of the plasticizer include phthalate plasticizers, adipate plasticizers, polyester plasticizers, etc. As long as the transparency of the resins is maintained, the resins may contain additives such as plasticizers, fillers, reinforcing materials such as glass fiber, flame-retardants, antioxidants, UV aboserbers, etc. according to the desired objects.

The thickness of the thermoplastic resin film is not specifically limited, and is preferably from 10 μm to 200 μm. When the thickness of the film is larger than 200 μm, the film tends to lose flexibility and the processability of the film may deteriorate. When the thickness of the film is less than 10 μm, the handling of the film during the production of the shading decorative sheet becomes difficult.

The decorative layer 2 is usually formed on the front surface of the thermoplastic resin film using colorants. The decorative layer 2 may be formed on the front surface of the thermoplastic resin film by any of conventional printing methods such as gravure printing, electrostatic printing, electrophotography, screen printing, ink jet printing, offset printing, thermal transferring, etc. The colorants used to form the decorative layer 2 are usually toners or inks.

FIG. 2 is a schematic plan view of the shading decorative sheet of FIG. 1, viewed from the side of the decorative layer 2. The decorative layer has a gradation pattern, which has the part 21 consisting of an opaque region, the part 22 consisting of an opaque region having a plurality of discrete transparent regions, the part 23 consisting of a transparent region having a plurality of discrete opaque regions, and the part 24 consisting of a transparent region.

The part 21 consisting of an opaque region has substantially no transparent region. Thus, an object behind the sheet cannot be seen through this part. The part 21 consisting of an opaque region may be formed using a single colorant. As long as the haze measured according to ASTM D 1003-00 is at least 30%, a plurality of colorants may be used to form graphics, patterns, etc. Herein, the haze is a measure indicating a degree of cloudiness visually seen. When an opaque region has a haze of less than 30%, an object behind the sheet can be seen through such an opaque part, and thus a non-recognizable part cannot be provided.

The haze is preferably at least 35%, more preferably at is least 70%.

The part 22 consisting of an opaque region having a plurality of discrete transparent regions includes the transparent regions 25 which can be seen transparently with an eye. A ratio of the area of the transparent regions to that of the opaque region is so designed that it increases with leaving from the part 21 consisting of an opaque part. The shape of the transparent region 25 may be a circle, a square, a rectangle, a triangle or any other shape. The transparent regions 25 having different shapes may be used. The size of the transparent region may be as follows:
A circle has a diameter of at least 0.1 mm, a rectangle has a side length of at least 0.1 mm, and a triangle has a side length of at least 0.1 mm. Preferably, the sizes of the transparent regions 25 increase with leaving from the part 21 consisting of an opaque region.

The part 23 consisting of a transparent region having a plurality of discrete opaque regions includes opaque regions 26 having a haze of at least 30% when measured according to ASTM D 1003-00. A ratio of the area of the opaque regions to that of the transparent region is so designed that it decreases with approaching to the part 24 consisting of a transparent part. The shape of the opaque region 26 may be a circle, a square, a rectangle, a triangle or any other shape. The size of the opaque region may be as follows:
A circle has a diameter of at least 0.1 mm, a rectangle has a side length of at least 0.1 mm, and a triangle has a side length of at least 0.1 mm. Preferably, the sizes of the opaque regions 26 decrease with approaching to the part 24 consisting of a transparent region.

To allow a relatively large object such as a face, arms, legs, etc. of a man behind the shading decorative sheet to be recognized, the shading decorative sheet is adhered to a transparent body so that a shielding area S (%) of the shading decorative sheet, which is on a line connecting an eye and an object to be seen, is less than 90%. The shielding area S will be defined in the Examples described below.

To allow a relatively small complicated object such as characters behind the shading decorative sheet to be recognized, the shading decorative sheet is adhered to the transparent body so that the shielding area S is less than 50%.

In the present invention, the gradation pattern preferably has the above four parts. As long as the effects of the present invention are not impaired, the gradation pattern may have the part 21 consisting of an opaque region, the part 22 consisting of an opaque region having a plurality of discrete transparent regions, and the part 24 consisting of a transparent region; or the part 21 consisting of an opaque region, the part 23 consisting of a transparent region having a plurality of discrete opaque regions, and the part 24 consisting of a transparent region; or the part 21 consisting of an opaque region, the part 22 consisting of an opaque region having a plurality of discrete transparent regions, and the part 23 consisting of a transparent region having a plurality of discrete opaque regions; or the part 22 consisting of an opaque region having a plurality of discrete transparent regions, the part 23 consisting of a transparent region having a plurality of discrete opaque regions, and the part 24 consisting of a transparent region.

Alternatively, the gradation pattern may have the part 22 consisting of an opaque region having a plurality of discrete transparent regions, and the part 23 consisting of a transparent region having a plurality of discrete opaque regions.

Furthermore, the gradation pattern may have the parts 23 consisting of a transparent region having a plurality of discrete opaque regions, the parts 22 consisting of an opaque region having a plurality of discrete transparent regions, and the parts 21 consisting of an opaque region, in this order, on the respective side of the part 24 consisting of a transparent region (21→22→23→24→23→22→21); or the parts 22 consisting of an opaque region having a plurality of discrete transparent regions, the parts 23 consisting of a transparent region having a plurality of discrete opaque regions, and the parts 24 consisting of a transparent region, in this order, on the respective side of the part 21 consisting of an opaque region (24→23→22→21→22→23→24); or any combination of the above gradation-patterns.

To form the decorative layer using no colorant, a metal is vapor deposited on the whole surface of the base layer, and the deposited metal layer is removed by etching from parts corresponding to the transparent regions to form a desired decorative layer, or a colored cutting film is cut to form a desired shape and adhered to the surface of the based layer to form the opaque regions.

The adhesive layer 3, which is used to adhere the shading decorative sheet to an adherent, may be formed as follows:
A liner having a release surface is provided. On the release surface, a coating composition comprising a self-adherent polymer (an adhesive paint for forming an adhesive layer of the sheet) is applied and dried to form an adhesive layer. Then, the liner carrying the adhesive layer is laminated on the base layer so that the adhesive layer is in contact with the back face of the base layer. Thereby, the adhesive layer having the liner is formed on the back face of the base layer. The liner may be peeled from the sheet just before the shading decorative sheet is adhered to the adherent.

Usually, the liner may be made of a paper sheet or a plastic film. The paper liner is prepared by laminating a releasing coat (a release layer) such as a polyethylene coat, a silicone coat, etc. on the surface of the paper sheet. When the silicone release coat is laminated, usually an under coat such as a clay coat, a polyethylene coat, etc. is laminated, and then the release coat is laminated.

For example, the adhesive layer is formed from a coating film of an adhesive comprising a self-adherent polymer. A preferable adhesive contains a self-adherent polymer and a crosslinking agent to crosslink the self-adherent polymer. Herein, the “self-adherent polymer” means a polymer having tackiness at room temperature. Examples of such a polymer include acrylic polymers, polyurethane, polyolefin, polyester, etc.

One example of the synthesis of the self-adherent polymer is explained by making reference to an acrylic polymer. As a first monomer, an acrylic unsaturated acid (e.g. acrylic acid, methacrylic acid, itaconic acid, maleic acid, etc.) or a polar (meth)acrylic monomer (e.g. acrylonitrile, etc.) is provided. The first monomer is mixed with an acrylic monomer as the second monomer to obtain a monomer mixture. As the second monomer, an alkyl acrylate such as isooctyl acrylate, butyl acrylate, 2-methylbutyl acrylate, 2-ethylhexyl acrylate, isononoyl acrylate, etc. may be used. The monomer mixture is polymerized by a conventional polymerization method such as solution polymerization, emulsion polymerization, bulk polymerization, etc. to synthesize a self-adherent polymer having a desirable molecular weight.

When a crosslinking agent is used to crosslink the self-adherent polymer, an amount of the crosslinking agent is usually from 0.02 to 2 parts by weight, preferably from 0.03 to 1 part by weight, per 100 parts by weight of the self-adherent polymer. Examples of the crosslinking agent include isocyanate compounds, melamine compounds, poly(meth)acrylate compounds, epoxy compounds, amide compounds, bisamide compounds (e.g. bisaziridine derivatives of dibasic acids such as isophthaloyl bis(2-methylaziridine), etc.

The thickness of the adhesive layer is preferably from 20 to 100 μm, more preferably from 25 to 80 μm. As long as the effects of the present invention are not impaired, the adhesive layer may contain additives such as tackifiers, elastic microspheres, microspheres of tacky polymers, crystalline polymers, inorganic powders, UV-ray absorbers, etc.

The shading decorative sheet of the present invention can be adhered to various adherents, for example, panes and partitions of buildings and windows of vehicles through the adhesive layer which is provided on the back face of the base layer.

### EXAMPLES

The present invention will be illustrated by the following examples, which do not limit-the scope of the invention in any way.

### Example 1

A film for a pane (Scotchtint® 2HSCL available from Sumitomo 3M) was provided as a film consisting of the base layer 1 and the adhesive layer 3 formed on the back face of the base layer. This film had a visible light transmission of 88% in a visible light wavelength range of 380 nm to 780 nm according to JIS 5759.

The front face of the film (the surface of the base layer 1) was gravure printed using a commercial ink (MILKY MAT available from TOYO HOUZAI IABUSHIKIKAISHA) to obtain a shading decorative sheet. The printed pattern had the part 21 consisting of an opaque region, the part 22 consisting of an opaque region having a plurality of discrete transparent regions, the part 23 consisting of a transparent region having a plurality of discrete opaque regions, and the part 24 consisting of a transparent region, as shown in the left figure of FIG. 2. The graph in the right side of FIG. 2 shows the length of each part in the degradation direction (which is not the same as the actual length), and also the percentage (%) of the opaque regions in each part.

The part 21 consisting of an opaque region has a length (27) of 200 mm, and a width of 600 mm. This opaque region had a haze of 97% according to ASTM D 1003-00.

The part 22 consisting of an opaque region having a plurality of discrete transparent regions had a length (28) of 570 mm and a width of 600 mm. The shape of the transparent region 25 was a circle. The diameters of the circular transparent regions 25 were the same in the width direction, while they increased in the longitudinal direction with leaving from the part 21 consisting of an opaque region. The smallest diameter of the transparent regions 25 was 0.1 mm, while the largest diameter was 3 mm.

The length (30) of the part 24 consisting of the transparent region was 10 mm.

The part 23 consisting of a transparent region having a plurality of discrete opaque regions has a length (29) of 490 mm and a width of 600 mm. The shape of the transparent region 25 was a circle. The diameters of the circular opaque regions 26 were the same in the width direction, while they decreased in the longitudinal direction with approaching to the part 24 consisting of a transparent region. The smallest diameter of the opaque regions 26 was 1 mm, while the largest diameter was 3 mm.

The shading decorative sheet produced in the above step as adhered to a transparent partition glass using the adhesive layer and maintained at room temperature for 24 hours. Then, the following experiment was carried out.

Shielding Effect

An object and the partition glass to which the shading decorative sheet was adhered were placed so that a distance between the eye of a viewer and the partition glass (Distance A) was 2 m, while a distance between the partition glass and the object (Distance B) was 0.5 m or 0.3 m (see FIG. 3). In this experiment, the object was (1) a cube (10 cm×10 cm×10 cm) or (2) a character of 2 cm square. In this case, the luminance on the viewer side was 100 lx, while that on the object side was 50 lx.

Then, the shielding area (defined by the following formula (1)) at a part of the shading decorative sheet, which was on the line connecting the eye of the viewer and the object, was measured, and also it was checked whether the contour of the object could be recognized when the object was viewed through the above part of the sheet.

The results are shown in Table 1.
Shielding area S(%)=[S₁(cm²)/100(cm²)]×100 (1)
wherein S₁ is a total area of the opaque region(s) in an area of 10 cm×10 cm (unit: cm²)

### Example 2

A shading decorative sheet was produced in the same manner as in Example 1 except that an ink of Teikoku Ink Co., Ltd. (EG-30418 SP (Ultra-white)) was used as an ink and the opaque region had a haze of 99%. Then the same experiment as Example 1 was carried out. The results are shown in Table 2.

### Example 3

A shading decorative sheet was produced in the same manner as in Example 2 except that the opaque region had a haze of 71%. Then the same experiment as Example 1 was carried out. The results are shown in Table 3.

### Example 4

A shading decorative sheet was produced in the same manner as in Example 2 except that the opaque region had a haze of 35%. Then the same experiment as Example 1 was carried out. The results are shown in Table 4.

### Comparative Example 1

A shading decorative sheet was produced in the same manner as in Example 1 except that the opaque region had a haze of 12%. Then the same experiment as Example 1 was carried out. In this case, since the haze of the opaque region was less than 30%, the contours of the objects could be recognized when the objects were seen through the region having a shielding area of 100% (the part consisting of an opaque region).

TABLE 1
Relationship between Shielding Area and Recongnizability
of objects (Haze of opaque region: 97%)

| | | | Recogniz- |
|---|---|---|---|
| | Shielding | Distance B between | ability of |
| Object | Area S (%) | Glass and Object | Contour¹⁾ |
| (1) Cube | 100% | 0.3 m | C |
| (1) Cube | 95% | 0.3 m | B |
| (1) Cube | 90% | 0.3 m | A |
| (2) Character | 80% | 0.3 m | C |
| (2) Character | 70% | 0.3 m | B |
| (2) Character | 50% | 0.3 m | A |
| (1) Cube | 100% | 0.5 m | C |
| (1) Cube | 95% | 0.5 m | B |
| (1) Cube | 90% | 0.5 m | A |
| (2) Character | 80% | 0.5 m | C |
| (2) Character | 70% | 0.5 m | B |
| (2) Character | 40% | 0.5 m | A |

Note:
¹⁾A: Recognized
B: Scarcely recognized
C: Not recognized

TABLE 2
Relationship between Shielding Area and Recongnizability
of objects (Haze of opaque region: 99%)

| | | | Recogniz- |
|---|---|---|---|
| | Shielding | Distance B between | ability of |
| Object | Area S (%) | Glass and Object | Contour¹⁾ |
| (1) Cube | 100% | 0.3 m | C |
| (1) Cube | 90% | 0.3 m | B |
| (1) Cube | 80% | 0.3 m | A |
| (2) Character | 70% | 0.3 m | C |
| (2) Character | 60% | 0.3 m | B |
| (2) Character | 40% | 0.3 m | A |
| (1) Cube | 100% | 0.5 m | C |
| (1) Cube | 90% | 0.5 m | B |
| (1) Cube | 80% | 0.5 m | A |
| (2) Character | 70% | 0.5 m | C |
| (2) Character | 50% | 0.5 m | B |
| (2) Character | 30% | 0.5 m | A |

Note:
¹⁾See Note 1) for Table 1.

TABLE 3
Relationship between Shielding Area and Recongnizability
of objects (Haze of opaque region: 71%)

| | | | Recogniz- |
|---|---|---|---|
| | Shielding | Distance B between | ability of |
| Object | Area S (%) | Glass and Object | Contour¹⁾ |
| (1) Cube | 100% | 0.3 m | C |
| (1) Cube | 95% | 0.3 m | B |
| (1) Cube | 90% | 0.3 m | A |
| (2) Character | 80% | 0.3 m | C |
| (2) Character | 70% | 0.3 m | B |
| (2) Character | 50% | 0.3 m | A |
| (1) Cube | 100% | 0.5 m | C |
| (1) Cube | 95% | 0.5 m | B |
| (1) Cube | 90% | 0.5 m | A |
| (2) Character | 80% | 0.5 m | C |
| (2) Character | 70% | 0.5 m | B |
| (2) Character | 40% | 0.5 m | A |

Note:
¹⁾See Note 1) for Table 1.

TABLE 4
Relationship between Shielding Area and Recongnizability
of objects (Haze of opaque region: 35%)

| | | | Recogniz- |
|---|---|---|---|
| | Shielding | Distance B between | ability of |
| Object | Area S (%) | Glass and Object | Contour¹⁾ |
| (1) Cube | 100% | 0.3 m | C |
| (1) Cube | 95% | 0.3 m | B |
| (1) Cube | 90% | 0.3 m | A |
| (2) Character | 80% | 0.3 m | C |
| (2) Character | 70% | 0.3 m | B |
| (2) Character | 50% | 0.3 m | A |
| (1) Cube | 100% | 0.5 m | C |
| (1) Cube | 95% | 0.5 m | B |
| (1) Cube | 90% | 0.5 m | A |
| (2) Character | 80% | 0.5 m | C |
| (2) Character | 70% | 0.5 m | B |
| (2) Character | 40% | 0.5 m | A |

Note:
¹⁾See Note 1) for Table 1.

What is claimed is:

1. A shading decorative sheet comprising:
a transparent base layer having a back face and a front face opposing to the back face, which comprises a thermoplastic resin film,
a decorative layer provided on said front face of the base layer, which has a gradation pattern at least in one direction, and
an adhesive layer fixedly provided on said back face of the base layer,
wherein said gradation pattern comprises an opaque region having a haze of at least 30% when measured according to ASTM D 1003-00 and a transparent region, and a ratio of the areas of the two regions is changed at least in one direction.

2. The shading decorative sheet according to claim 1, wherein said gradation pattern comprises a part consisting of the opaque region, a part consisting of the opaque region having a plurality of discrete transparent regions, a part consisting of the transparent region having a plurality of discrete opaque regions, and a part consisting of the transparent region.

3. The shading decorative sheet according to claim 1, wherein said gradation pattern comprises a part consisting of the opaque region, a part consisting of the opaque region having a plurality of discrete transparent regions, and a part consisting of the transparent region.

4. The shading decorative sheet according to claim 1, wherein said gradation pattern comprises a part consisting of the opaque region, a part consisting of the transparent region having a plurality of discrete opaque regions, and a part consisting of the transparent region.

5. The shading decorative sheet according to claim 1, wherein said gradation pattern comprises a part consisting of the opaque region, a part consisting of the opaque region having a plurality of discrete transparent regions, and a part consisting of the transparent region having a plurality of discrete opaque regions.

6. The shading decorative sheet according to claim 1, wherein said gradation pattern comprises a part consisting of the opaque region having a plurality of discrete transparent regions, a part consisting of the transparent region having a plurality of discrete opaque regions, and a part consisting of the transparent region.

7. The shading decorative sheet according to claim 1, wherein said gradation pattern comprises a part consisting of the opaque region having a plurality of discrete transparent regions, and a part consisting of the transparent region having a plurality of discrete opaque regions.

8. The shading decorative sheet according to claim 1, wherein a boundary between a recognizable part and a non-recognizable part is determined by a shielding area S (%) which is defined by the following formula (1):
S(%)=[S₁(cm²)/100(cm²)]×100 (1)
wherein S₁ is a total area (cm²) of the opaque region(s) in an area of 10 cm×10 cm.
